(19) United States
(12) Patent Application Publication
(10) Pub. No.: US 2008/0071534 A1
(43) Pub. Date: Mar. 20, 2008

(54) Methods for using an interactive voice recognition system

(75) Inventor: Richard A. Johnson, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/521,236

(22) Filed: Sep. 14, 2006

(51) Int. Cl. G10L 17/00

(52) U.S. Cl. 704/246

(57) ABSTRACT

A method for using an interactive voice recognition system for communication between a user and a service provider includes establishing a connection between the user and the interactive voice recognition system. The availability of a human advisor located at a call center is monitored. If a first user response is mis-recognized by the interactive voice recognition system, and the human advisor is unavailable, the method further includes attempting to recognize a second user response via the interactive voice recognition system. If the first user response or the second user response is mis-recognized by the interactive voice recognition system, and the human advisor is available, the method further includes transferring the connection so that the user is connected with the human advisor.

### TECHNICAL FIELD

The present disclosure relates generally to methods for using an interactive voice recognition system.

### BACKGROUND

Interactive voice recognition (IVR) systems generally have improved service efficiency when compared to traditional systems which utilize human advisors. Voice recognition systems require human advisors to intervene when the IVR system is unable to recognize (or mis-recognizes) a user utterance. Some IVR systems transfer a user to a human advisor after an utterance is mis-recognized. If an advisor is unavailable, the user will be placed on hold until an advisor is available. In such an IVR system, the user may hear silence, ring tones, music, and/or advertisements while on hold. Once the user is placed on hold to wait for the next available advisor, he or she is no longer connected to the voice recognition portion of the system.

As such, it would be desirable to provide an interactive voice recognition system that obviates at least some of the current IVR system inefficiencies.

### SUMMARY

A method for using an interactive voice recognition system for communication between a user and a service provider is disclosed. The method includes establishing a connection between the user and the interactive voice recognition system (for example, via an in-vehicle telematics unit). The availability of a human advisor located at a call center is monitored. If a first user response is mis-recognized by the interactive voice recognition system, and the human advisor is unavailable, the method further includes attempting to recognize a second user response via the interactive voice recognition system. If the first user response or the second user response is mis-recognized by the interactive voice recognition system, and the human advisor is available, the method further includes transferring the connection so that the user is connected with the human advisor.

### BRIEF DESCRIPTION OF THE DRAWINGS

Objects, features and advantages of embodiments of the present disclosure may become apparent by reference to the following detailed description and drawings, in which like reference numerals correspond to similar, though not necessarily identical components. For the sake of brevity, reference numerals having a previously described function may not necessarily be described in connection with other drawings in which they appear.

FIG. 1 is schematic diagram depicting an embodiment of an interactive voice recognition system; and

FIG. 2 is a flow diagram depicting an embodiment of the method disclosed herein.

### DETAILED DESCRIPTION

Embodiment(s) of the system and method disclosed herein advantageously allow a user to continue communication with an interactive voice recognition system while a human advisor is unavailable. The communication with the interactive voice recognition system is configured to continue until the user's request is fulfilled and/or until a human advisor is available to assist the user.

It is to be understood that, as defined herein, a user may include vehicle operators and/or passengers.

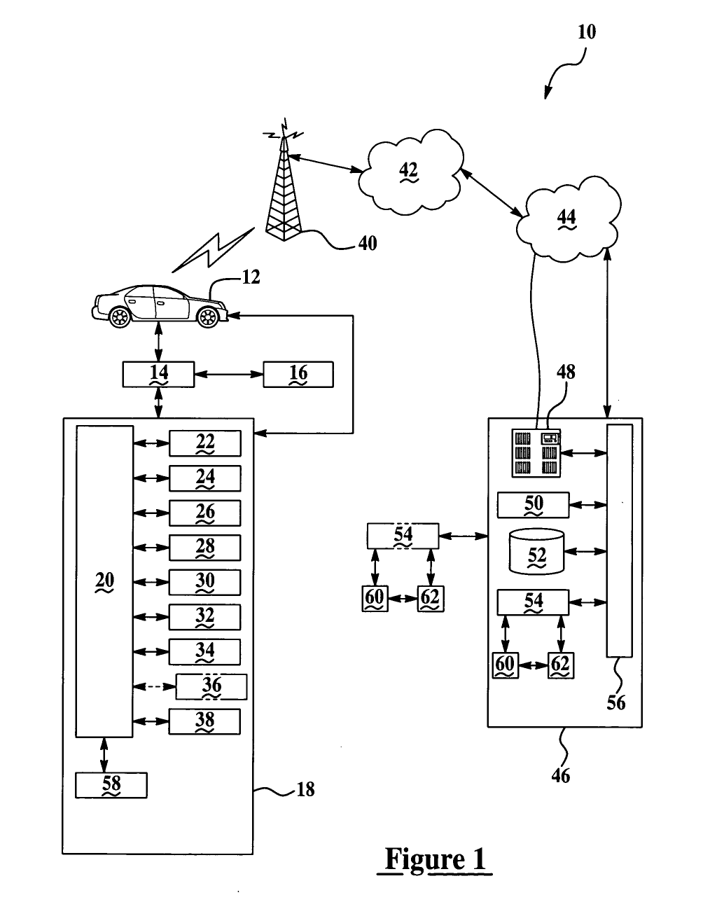

Referring now to FIG. 1, the system 10 includes a vehicle 12, a vehicle communications network 14, a telematics unit 18, and a wireless communication system (including, but not limited to, one or more wireless carrier systems 40, one or more communication networks 42, and/or one or more land networks 44). In an embodiment, the wireless communication system is a two-way radio frequency communication system. In another embodiment, the wireless communication system also includes one or more call centers/service providers 46. In yet another embodiment, vehicle 12 is a mobile vehicle with suitable hardware and software for transmitting and receiving voice and data communications. System 10 may include additional components suitable for use in telematics units 18.

In an embodiment, via vehicle communications network 14, the vehicle 12 sends signals from the telematics unit 18 to various units of equipment and systems 16 within the vehicle 12 to perform various functions, such as unlocking a door, executing personal comfort settings, and/or the like. In facilitating interaction among the various communications and electronic modules, vehicle communications network 14 utilizes interfaces such as controller area network (CAN), ISO standard 11989 for high speed applications, ISO standard 11519 for lower speed applications, and Society of Automotive Engineers (SAE) standard J1850 for high speed and lower speed applications.

The telematics unit 18 may send and receive radio transmissions from wireless carrier system 40. In an embodiment, wireless carrier system 40 may be a cellular telephone system and/or any other suitable system for transmitting signals between the vehicle 12 and communications network 42. Further, the wireless carrier system 40 may include a cellular communication transceiver, a satellite communications transceiver, a wireless computer network transceiver (a non-limitative example of which includes a Wide Area Network (WAN) transceiver), and/or combinations thereof.

Telematics unit 18 may include a processor 20 operatively coupled to a wireless modem 22, a location detection system 24 (a non-limitative example of which is a global positioning system (GPS)), an in-vehicle memory 26, a microphone 28, one or more speakers 30, an embedded or in-vehicle mobile phone 32, a TTY unit 36, and/or a short-range wireless communication network 38 (e.g. a Bluetooth® unit).

It is to be understood that the telematics unit 18 may be implemented without one or more of the above listed components, such as, for example, speakers 30. Yet further, it is to be understood that the speaker(s) 30 may be a component of the vehicle audio system (which includes a receiver), which may, in addition to radio broadcasts, accept audio and other signals from the telematics unit 18. Telematics unit 18 may include additional components and functionality as desired for a particular end use.

Processor 20 may be a micro controller, a controller, a microprocessor, a host processor, and/or a vehicle communications processor. In another embodiment, processor 20 may be an application specific integrated circuit (ASIC). Alternatively, processor 20 may be a processor working in conjunction with a central processing unit (CPU) performing the function of a general-purpose processor.

Non-limitative examples of the location detection system 24 include a Global Position Satellite receiver, a radio triangulation system, a dead reckoning position system, and/or combinations thereof. In particular, a GPS receiver provides accurate time and latitude and longitude coordinates of the vehicle 12 responsive to a GPS broadcast signal received from a GPS satellite constellation (not shown). In-vehicle mobile phone 32 may be a cellular type phone, such as, for example an analog, digital, dual-mode, dual-band, multi-mode and/or multi-band cellular phone, and/or may be a TTY-compatible mobile phone.

Associated with processor 20 is a real time clock (RTC) 34 providing accurate date and time information to the telematics unit hardware and software components that may require date and time information. In one embodiment, date and time information may be requested from the RTC 34 by other telematics unit components. In other embodiments, the RTC 34 may provide date and time information periodically, such as, for example, every ten milliseconds.

The TTY unit 36 is a telecommunications device for a hearing-impaired user. The TTY unit 36 may include external components, such as a keyboard or a vibrating wristband, used, for example, to alert the hearing-impaired user of an incoming communication.

Processor 20 may execute various computer programs that interact with operational modes of electronic and mechanical systems within the vehicle 12. It is to be understood that processor 20 controls communication (e.g. signals such as call signals) between telematics unit 18, wireless carrier system 40, and call center 46.

Further, processor 20 may generate and accept digital signals transmitted between the telematics unit 18 and the vehicle communication network 14, which is connected to various electronic modules in the vehicle 12. In one embodiment, these digital signals activate the programming mode and operation modes within the electronic modules, as well as provide for data transfer between the electronic modules. In another embodiment, certain signals from processor 20 may be translated into vibrations and/or visual alarms.

It is to be understood that software 58 may be associated with processor 20 for monitoring and/or recording the incoming caller utterances.

The communications network 42 may include services from one or more mobile telephone switching offices and/or wireless networks. Communications network 42 connects wireless carrier system 40 to land network 44. Communications network 42 may be any suitable system or collection of systems for connecting the wireless carrier system 40 to the vehicle 12 and the land network 44.

The land network 44 connects the communications network 40 to the call center/service provider 46. In one embodiment, land network 44 is a public switched telephone network (PSTN). In another embodiment, land network 44 is an Internet Protocol (IP) network. In still other embodiments, land network 44 is a wired network, an optical network, a fiber network, another wireless network, and/or any combinations thereof. The land network 44 may be connected to one or more landline telephones. It is to be understood that the communications network 42 and the land network 44 connect the wireless carrier system 40 to the service provider/call center 46.

Call center 46 contains one or more data switches 48, one or more communication services managers 50, one or more communication services databases 52 containing subscriber profile records and/or subscriber information, one or more communication services advisors 54, and/or one or more network systems 56.

Switch 48 of call center 46 connects to land network 44. Switch 48 transmits voice or data transmissions from call center 46, and receives voice or data transmissions from telematics unit 18 in vehicle 12 through wireless carrier system 40, communications network 42, and land network 44. Switch 48 receives voice transmissions from, or sends voice transmissions to one or more service advisors 54 via one or more network systems 56. Switch 48 receives data transmissions from, or sends data transmissions to one or more communication services managers 50 via one or more network systems 56.

Call center 46 may contain, or may be in communication with one or more service advisors 54. In one embodiment, service advisor 54 is an interactive voice recognition system 60. In another embodiment, the service advisor 54 is a human advisor 62. It is to be understood that the call center 46 may include or be in communication with both an interactive voice recognition system 60 and human advisor(s). Furthermore, the interactive voice recognition system 60 and the human advisor(s) 62 are in selective communication with each other and with the telematics unit 18. In an embodiment, the interactive voice recognition system 60 is located at least partially in the telematics unit 18.

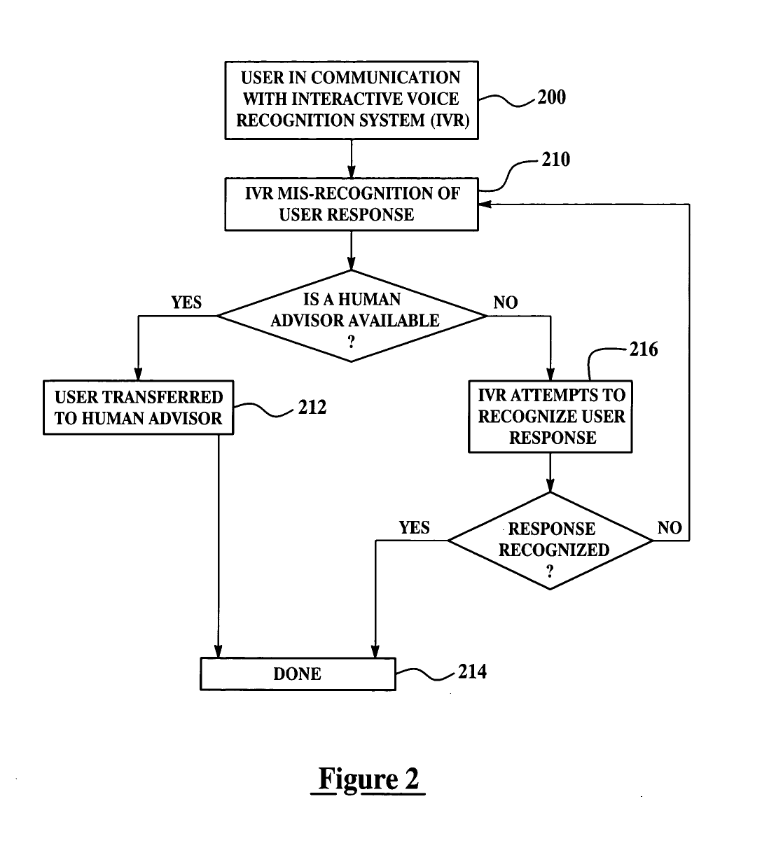

Referring now to FIG. 2, an embodiment of the method disclosed herein is depicted. Generally, the user/operator initiates a call or a communication request with a service advisor 54 located at, or in communication with, the service provider/call center 46. In an embodiment, the user initiates communication in order to request, for example, emergency services (e.g., police, fire, ambulance, etc.), a navigation route, a service (e.g., upgrade service plan, purchase more mobile phone 32 minutes, etc.), initiation of a phone call, implementation of a preferred in-vehicle setting, or the like, or combinations thereof.

The call or communication request may be initiated via an input system. The input system is in communication with the two-way radio frequency communication system. Initiation of the request may be verbal and/or via a physical motion. As such, the input system may include an alphanumeric keypad, a microphone 28, a menu selection system, and/or combinations thereof.

Verbal communication may take place via microphone 28 coupled to the in-vehicle or mobile phone 32 associated with the telematics unit 18. Caller utterances into the microphone 28 are received at a call center 46, which tokenizes the utterance stream for further processing. In one embodiment, the tokenized utterances are placed in a subscriber information database 52 at the call center 46.

Physically initiating a request may be accomplished via a button press, touch screen, or the like located in the vehicle 12. It is to be understood that the button press or touch screen is operatively connected to the telematics unit 18. Upon the user's initiation of the button press or touch screen, the telematics unit 18 signals the call center 46 of the fact that the user has initiated a request.

A user may make a request for communication with the call center 46 either verbally or by using a TTY unit 36. The TTY unit 36 may be useful in embodiment(s) of the present disclosure if, for example, the person inputting the communication request is hearing-impaired, but the user/operator of the vehicle 12, who will be communicating with the interactive voice recognition system 60 and/or the human advisor 62 is not hearing-impaired.

In an embodiment of the method, once the user initiates the request, the telematics unit 18 connects the user to the interactive voice recognition system 60 via the two-way radio frequency communication system (e.g., wireless carrier system(s) 40, communication network(s) 42, and/or land network(s) 44), as shown at reference numeral 200. Once the connection is established, the interactive voice recognition system 60 attempts to assist the user in fulfilling the request(s).

Throughout the duration of the connection between the user and the interactive voice recognition system 60, the availability of one or more human advisors 62 is monitored. Generally, such monitoring may be accomplished via an arbitration control that may be in communication with communications services manager 50 as an example, or may be embodied within the IVR system 60, as another example.

In an embodiment, the availability of the human advisor(s) 62 may be monitored by tracking and comparing the number of active advisor communication lines (i.e., line(s) currently utilized by an advisor) with the number of advisors 62 on duty. If the number of active advisor communication lines is less than the number of advisors 62 on duty, then one or more advisors 62 should be available. If the number of active advisor communication lines is equal to the number of advisors 62 on duty, then no human advisors 62 are currently available. As a non-limiting example, if fifteen advisors 62 are on duty, and thirteen advisor communication lines are active (e.g., busy), it is presumed that two human advisors 62 are available.

The advisor communication lines may be monitored by software located within the communication services manager(s) 50. The communication services manager(s) 50 may send one or more status/request signals to, or receive one or more status/request signals from the interactive voice recognition system 60. In another embodiment, the system for monitoring availability of advisor lines is at least partially embodied in the interactive voice recognition system 60.

The availability of the human advisor(s) 62 is monitored so that if the interactive voice recognition system 60 substantially continuously encounters difficulties in communicating with the user, the user may be connected to the first available human advisor 62, without having to be put on hold.

In an embodiment, the human advisor(s)' 62 availability is monitored substantially continuously. In another embodiment, the human advisor(s)' 62 availability is monitored at predetermined intervals. Non-limitative examples of such predetermined intervals include pre-set time intervals (e.g., every 30 seconds), when mis-recognition of a user utterance occurs, or the like, or combinations thereof.

After the connection between the user and the interactive voice recognition system 60 is established, the user expresses his or her request to the system 60. This is generally accomplished via verbal communication. The user's verbal utterance is picked up by the mobile phone 32 of the telematics unit 18, which transmits the utterance or response to the interactive voice recognition system 60. The interactive voice recognition system 60 receives and attempts to recognize the utterance or response.

In an embodiment, an interactive voice recognition system 60 may recognize speech by comparing user utterances/responses to sets of phonemes that represent one or more words. If an utterance satisfactorily corresponds with a set of phonemes, then the interactive voice recognition system 60 may establish a match between the utterance and the word(s) represented by the set of phonemes. Upon establishing a match, the interactive voice recognition system 60 may be configured to take an action (one non-limiting example of which may be to dial a phone number), which has been previously associated with the word(s) represented by the set of phonemes.

In an embodiment of the method, the interactive voice recognition system 60 is unable to discern, or mis-recognizes, the user utterance, as shown at reference numeral 210. Generally, “mis-recognition,” as used herein, means that the interactive voice recognition system 60 does not understand or misunderstands all or a portion of the user utterance.

In response to this mis-recognition, the system 60 checks for the availability of a human advisor 62. In an embodiment in which the system 60 monitors advisor 62 availability substantially continuously throughout the connection, the system 60 may be aware of the status of the human advisor(s) 62 substantially simultaneously with the occurrence of the mis-recognition. As a non-limiting example, substantially immediately after detecting a mis-recognition, software resident in the communication services manager(s) 50 may receive notice of the mis-recognition, which notice may be in the form of an interrupt. In response to the notice, the communication services manager(s) 50 may substantially immediately perform a scan for an available human advisor 62.

In an embodiment in which the system 60 monitors advisor 62 availability upon the occurrence of the mis-recognition, the system 60 may be aware of the status of the human advisor(s) 62 within a brief period of checking the availability. As such, the communication services manager(s) 50 may be configured to continuously or periodically scan for an available human advisor 62 for a brief period. As a non-limiting example, a brief period may be about 30 seconds to about 60 seconds. If an available human advisor 62 is not detected during the brief period, then the communication services manager(s) 50 may transmit a signal, such as to the interactive voice recognition system 60 (e.g. when the scanning software is resident within communications services manager 50), that a human advisor 62 is not available.

If a human advisor 62 is available, the interactive voice recognition system 60 informs the user that he or she will be transferred to the human advisor 62 for further assistance. The interactive voice recognition system 60 is in selective communication with the human advisor 62, and is capable of transferring the connection so that a connection between the user and the human advisor 62 is established, as shown at reference numeral 212. Once the human advisor 62 fulfills the request, the connection is ended, as shown at reference numeral 214.

If a human advisor 62 is not available, the interactive voice recognition system 60 will request that the user repeat at least a portion of the previous utterance or provide the system 60 with additional information pertaining to the user's request. The user then responds with a second utterance. The interactive voice recognition system 60 attempts to recognize this second utterance. If the second utterance is mis-recognized, the interactive voice recognition system 60 will again check the availability of the human advisor(s) 62. If a human advisor 62 is again unavailable, the interactive voice recognition system 60 will again ask that the user repeat at least a portion of one or both of the previous two utterances, or provide the system 60 with additional information pertaining to the request.

It is to be understood that the interactive voice recognition system 60 will attempt to recognize as many subsequent utterances as are provided by the user, whether they are repeated or new utterances, as shown at reference numeral 216. As previously stated, if subsequent user utterance(s) is/are also mis-understood or mis-recognized by the interactive voice recognition system 60, the system 60 will recheck the availability of the human advisor(s) 62. If a human advisor 62 remains unavailable, it is to be understood that the interactive voice recognition system 60 will continue to prompt the user for repeated or new utterances in an attempt to further assist the user. In an embodiment, the interactive voice recognition system 60 will continue to prompt the user at least until a human advisor 62 becomes available and/or the request has been fulfilled. In another embodiment, the interactive voice recognition system 60 will prompt the user a predetermined number of times. The predetermined number of times the interactive voice recognition system 60 prompts the user may be determined by a default threshold value. In a non-limiting example, the default threshold value may be three times. In yet another embodiment, the predetermined number of times may be configured within a user profile record maintained at the call center 46, such as within the communication services database(s) 52. It is to be understood, however, that the user may terminate the interaction at any time, as desired.

In an embodiment, the interactive voice recognition system 60 may initiate a sub-dialogue with the user in an attempt to obtain information that will allow the system 60 to fulfill the request. Generally, a sub-dialogue is initiated after an initial utterance is partially mis-recognized. The sub-dialogue generally begins with the interactive voice recognition system 60 asking the user a question that is designed to obtain information about the initial user request. When a sub-dialogue is initiated, the system 60 generally does not ask the user to repeat an entire prior utterance. Rather, the system 60 asks a question that is directed to obtaining the information given in the prior utterance in a different manner. For example, an initial user utterance may request navigation instructions to a specific address. If the interactive voice recognition system 60 recognizes the numbers of the address, but does not recognize the street name, the system 60 may ask the user to spell the street name. Alternately, the system 60 may ask the user to repeat the street name, but not the numbers. Still further, the system 60 may repeat back a perceived street name and inquire whether this information is accurate. If the user responds negatively, the system 60 may then ask the user for more information.

In the embodiments disclosed herein, the interactive voice recognition system 60 may recognize the user utterance(s) and fulfill the request prior to a human advisor 62 becoming available. In such embodiments, the connection between the user and the interactive voice recognition system 60 is ended without connecting the user to a human advisor 62.

As a non-limiting example of the method depicted in FIG. 2, a user initiates communication by calling the call center 46 using the in-vehicle or mobile phone 32 that is in communication with the telematics unit 18. The switch 48 at call center 46 connects the user with the interactive voice recognition system 60. Throughout the duration of this connection, in this example, the system 60 is monitoring the availability of human advisors 62. In another example, communications services manager(s) 50 may monitor the availability of human advisors 62.

The user verbally requests that the system 60 dial a telephone number. When the initial user utterance is complete, the system 60 repeats back to the user the telephone number it perceives and inquires if this number is correct. In this example, the user indicates to the system 60 that the perceived number is incorrect.

The interactive voice recognition system 60 checks to see if a human advisor 62 is available. In this example, all of the advisors 62 are currently unavailable, and so the system 60 asks the user to repeat the initial utterance (i.e., the system 60 asks for a first subsequent utterance). The user complies with the request, and the system 60 repeats back to the user the newly perceived telephone number and inquires if this is correct. In this example, the user indicates to the system that the area code of the newly perceived number is incorrect.

In response, the interactive voice system 60 again checks to see if a human advisor 62 is available to further assist the user. In one embodiment of this example, the human advisor 62 is available, and the user is connected to the human advisor 62. In another embodiment, the human advisor 62 is unavailable, and so the system 60 asks the user to repeat the area code of the telephone number (i.e., the system 60 asks for a second subsequent utterance). The user complies with the request, and the system 60 repeats back to the user the newly perceived area code and inquires if this is correct. In this example, the user indicates that the area code is correct, and the system 60 dials the correct number for the user. At this point, the connection between the user and the system 60 is terminated as the request has been fulfilled.

It is to be understood that embodiment(s) of the present disclosure are not intended to be limited to use within a telematics environment. On the contrary, embodiment(s) of the present disclosure are applicable and advantageous wherever an IVR system 60 and call center 46 with live advisors 62 are interacting.

The system(s) and method(s) described herein may advantageously improve user interaction through use of the interactive voice recognition system 60, which system 60 will attempt to take action (via repeated recognition attempts) on behalf of the user, without having to wait for human advisor 62 interaction. The system(s) and method(s) described herein may also advantageously minimize the time a user must wait for a service response through use of the interactive voice recognition system 60. By utilizing repeat attempts for recognition, the method(s) and system(s) may favorably decrease the length of time before a service response is realized, particularly when a human service advisor 62 is unavailable. Additionally, user wait time may be minimized by providing for substantially immediate interaction with a human advisor 62, when available, following a mis-recognition.

While several embodiments have been described in detail, it will be apparent to those skilled in the art that the disclosed embodiments may be modified. Therefore, the foregoing description is to be considered exemplary rather than limiting.

1. A method for using an interactive voice recognition system for communication between a user and a service provider, the method comprising:
establishing a connection between the user and the interactive voice recognition system; and
monitoring availability of a human advisor located at the service provider;
wherein if a first user response is mis-recognized by the interactive voice recognition system, and the human advisor is unavailable, the method further includes attempting to recognize a second user response via the interactive voice recognition system;
and wherein if the first user response or the second user response is mis-recognized by the interactive voice recognition system, and the human advisor is available, the method further includes transferring the connection so that the user is connected with the human advisor.

2. The method of claim 1 wherein the connection is established via an in-vehicle telematics unit.

3. The method of claim 1 wherein, prior to establishing the connection, the method further includes initiating a communication request from the user.

4. The method of claim 3 wherein the user initiates the communication request via at least one of verbal initiation or physical initiation.

5. The method of claim 3 wherein the communication request includes a request for at least one of an emergency service, a navigation route, a phone call, a service, a preferred in-vehicle setting, or combinations thereof.

6. The method of claim 5, further comprising terminating the connection after the request has been fulfilled.

7. The method of claim 1 wherein the human advisor is located at a call center.

8. The method of claim 1 wherein the connection is established via a two-way radio frequency communication system.

9. The method of claim 8 wherein the two-way radio frequency communication system includes at least one of a wireless carrier system, a communications network, a land network, or combinations thereof.

10. A method for using an interactive voice recognition system for communication between a user and a service provider, the method comprising:
establishing a connection, via an in-vehicle telematics unit, between a user and the interactive voice recognition system in selective communication with one or more human advisors;
monitoring availability of the one or more human advisors;
receiving a first user utterance at the interactive voice recognition system; and
attempting recognition of the first user utterance;
wherein the interactive voice recognition system is configured to attempt recognition of a second user utterance if the first user utterance is mis-recognized and if all of the one or more human advisors are unavailable;
and wherein the interactive voice recognition system is configured to establish communication between the user and one of the one or more human advisors if the first user utterance is mis-recognized and if one of the one or more human advisors is available.

11. The method of claim 10 wherein monitoring availability of the one or more human advisors includes continuously monitoring availability or monitoring availability at predetermined intervals throughout a duration of the connection between the user and the interactive voice recognition system.

12. The method of claim 10 wherein the first user utterance is mis-recognized, wherein attempting recognition of the second user utterance is accomplished by requesting the user to repeat the first user utterance, wherein the repeated user utterance is mis-recognized, and wherein attempting recognition of a third user utterance is accomplished by requesting information, other than the repeated user utterance, from the user.

13. The method of claim 10 wherein, prior to establishing the connection, the method further includes initiating a communication request from the user.

14. The method of claim 10 wherein the one or more human advisors are located at a call center.

15. The method of claim 10 wherein the connection is established via a two-way radio frequency communication system.

16. A communication system, comprising:
an in-vehicle telematics unit;
an interactive voice recognition system in selective communication with the in-vehicle telematics unit; and
at least one human advisor in selective communication with the interactive voice recognition system and the in-vehicle telematics unit;
wherein the interactive voice recognition system is configured to attempt recognition of at least one subsequent user utterance if an initial user utterance is mis-recognized and the at least one human advisor is unavailable;
and wherein the interactive voice recognition system is configured to establish communication between the user and the at least one human advisor if the initial user utterance is mis-recognized and the at least one human advisor is available.

17. The system of claim 16 wherein the interactive voice recognition system includes an arbitration control configured to monitor availability of the at least one human advisor, and to selectively switch a connection between the in-vehicle telematics unit and the interactive voice recognition system to a connection between the in-vehicle telematics unit and the at least one human advisor.

18. The system of claim 16, further comprising a two-way radio frequency communication system operatively connecting the in-vehicle telematics unit to the interactive voice recognition system and to the at least one human advisor.

19. The system of claim 16 wherein the interactive voice recognition system is configured to attempt recognition of a second of the at least one subsequent user utterance after mis-recognition of a first of the at least one subsequent user utterance.

20. The system of claim 19 wherein the interactive voice recognition system is configured to attempt recognition of subsequent user utterances until 1) the communication is established between the in-vehicle telematics system and the at least one human advisor or 2) a request of the user is fulfilled.

21. The system of claim 16 wherein the interactive voice recognition system is configured to initiate a sub dialogue with a user to attempt recognition of the at least one subsequent user utterance.
